(19) United States
(12) Patent Application Publication
(10) Pub. No.: US 2001/0046635 A1
(43) Pub. Date: Nov. 29, 2001

(54) Electrographic developer compositions and methods

(76) Inventors: Satyanarayan A. Srinivasan, Rochester, NY (US); Peter S. Alexandrovich, Rochester, NY (US); Robert D. Fields, Rochester, NY (US)

Correspondence Address: John L. Wood, Esq., Heidelberg Digital L.L.C., 2600 Manitou Road, Rochester, NY, 14624, US

(21) Appl. No.: 09/853,917

(22) Filed: May 11, 2001

Related U.S. Application Data
(60) Provisional application No. 60/204,942, filed on May 17, 2000.

(51) Int. Cl. G03G 9/08

(52) U.S. Cl. 430/108.3; 430/108.7; 430/111.4; 430/122

(57) ABSTRACT

Disclosed are developer compositions for use in an electrographic development process and methods for using such compositions. The developer includes a hard magnetic material as a carrier, and also a toner material which comprises a polymeric resin, colorant, and a hydrophobic silica or hydrophilic silica, in an amount sufficient to reduce the dusting of toner particles off of the carrier particles during use, as well as to maintain the charge to mass ratio of the toner during use so as to increase the useful life of the developer composition. Also disclosed are methods of using such developer compositions.

### CROSS REFERENCE TO RELATED APPLICATIONS

This Application claims benefit under 35 USC §119 (e) of prior co-pending U.S. Provisional Patent Application, Ser. No. 60/204,942, filed May 17, 2000, the disclosure of which is incorporated herein by reference in its entirety. Attention is also directed to the following related U.S. patent application: U.S. Ser. No. ______ (Attorney Docket No. 10044) entitled “Electrographic Methods Using Hard Magnetic Carrier Particles” filed concurrently on even date herewith, the disclosure of which is incorporated herein by reference in its entirety.

### FIELD OF THE INVENTION

This invention relates to electrography and more particularly it relates to developer compositions for the dry development of electrostatic charge images.

### BACKGROUND OF THE INVENTION

In electrography, an electrostatic charge image is formed on a dielectric surface, typically the surface of a photoconductive recording element. Development of this image is typically achieved by contacting it with a two-component developer comprising a mixture of pigmented resinous particles, known as toner, and magnetically attractable particles, known as carrier. The carrier particles serve as sites against which the non-magnetic toner particles can impinge and thereby acquire a triboelectric charge opposite to that of the electrostatic image, when using a charged area development configuration. The toner particles may similarly acquire a triboelectrical charge useful for a discharged area development configuration, as known in the art. During contact between the electrostatic image and the developer mixture, the toner particles are stripped from the carrier particles to which they had formerly adhered (via triboelectric forces) by the relatively strong electrostatic forces associated with the charge image. In this manner, the toner particles are deposited on the photoconductive element to render the latent electrostatic image visible.

It is generally known to apply developer compositions of the above type to electrostatic images by means of a magnetic applicator which comprises a cylindrical sleeve of non-magnetic material having a magnetic core positioned within. The core usually comprises a plurality of parallel magnetic strips which are arranged around the core surface to present alternating north and south oriented magnetic fields. These fields project radially, through the sleeve, and serve to attract the developer composition to the sleeve outer surface to form what is commonly referred to in the art as a “brushed nap”. Either or both of the cylindrical sleeve and the magnetic core are rotated with respect to each other to cause the developer composition to advance from a supply sump into a position in which the developer composition contacts the electrostatic image to be developed. After development, the toner depleted carrier particles are returned to the sump for toner replenishment.

Conventionally, carrier particles made of soft magnetic materials have been employed to carry and deliver the toner particles to the electrostatic image. U.S. Pat. Nos. 4,546,060, 4,473,029 and 5,376,492, the teachings of which are incorporated herein by reference in their entirety, teach the use of hard magnetic materials as carrier particles and also apparatus for the development of electrostatic images utilizing such hard magnetic carrier particles. These patents require that the carrier particles comprise a hard magnetic material exhibiting a coercivity of at least 300 Oersteds when magnetically saturated and an induced magnetic moment of at least 20 EMU/gm when in an applied magnetic field of 1000 Oersteds. U.S. Pat. No. 4,764,445 discloses hard magnetic ferrite carrier particles for electrographic developing applications which comprise lanthanum to yield a more conductive magnetic ferrite particle, thereby providing greater development efficiency and/or speed of development.

The terms “hard” and “soft” when referring to magnetic materials have the generally accepted meaning as indicated on page 18 of Introduction To Magnetic Materials by B. D. Cullity published by Addison-Wesley Publishing Company, 1972.

The hard magnetic carrier materials represent a great advance over the use of soft magnetic carrier materials in that the speed of development is remarkably increased with good image development. Speeds as high as four times the maximum speed utilized in the use of soft magnetic carrier particles have been demonstrated.

In the methods taught by the foregoing patents, developer comprised of a hard magnetic material is moved at essentially the same speed and direction as the electrostatic image to be developed by high speed rotation of the multi-pole magnetic core within the sleeve, with the developer being disposed on the outer surface of the sleeve. Rapid pole transitions on the sleeve are mechanically resisted by the carrier because of its high coercivity. Chains of carrier particles comprising the brushed nap of the carrier (with toner particles disposed on the surface of the carrier particles), rapidly “flip” on the sleeve in order to align themselves with the magnetic field reversals imposed by the rotating magnetic core, and as a result, move with the toner on the sleeve through the development zone in contact with or close relationship to the electrostatic image on the photoconductive element. This interaction of the developer with the charge image is referred to as “contact” or “contacting” hereinafter for purposes of convenience. Further, the sleeve may also be rotated to increase the velocity of the developer. See also, U.S. Pat. No. 4,531,832, the teachings of which are also incorporated herein in their entirety, for further discussion concerning such a process.

The rapid pole transitions, for example as many as 600 per second on the sleeve surface when the magnetic core is rotated at a speed of 2000 rpm, create a highly energetic and vigorous movement of developer as it moves through the development zone. This vigorous action constantly recirculates the developer to the sleeve surface and then back to the outside of the nap to provide toner for development. This flipping action also results in a continuous feed of fresh toner particles to the image. As described in the above-described patents, this method provides high density, high quality images at relatively high development speeds.

The direct interaction of the developer nap with the image member causes the developer to roll back toward the input side of the development zone. This rollback broadens the contact between the developer and the image member and thereby improves the development completion of the system.

The above-described development systems utilizing such hard magnetic carrier developers can have a tendency to display an increasing amount of “dusting” over time during use. The dusting phenomenon occurs when toner particles having a relatively low charge to mass (Q/m) are literally flung off the developer nap of the rotating magnetic core toning roller. The violent chain flipping action, as previously described, characteristic of these development systems is believed to contribute to the dusting problem. While not wishing to be bound by theory, the mechanism thought to be responsible for such dusting is that the rate of charging of fresh replenisher toner decreases due to the loss of carrier charging ability by factors, such as formation of a “scum”, i.e., build up of toner resin on the carrier surface and accumulation of fine particles of toner in the developer (larger particles develop preferentially over the smaller toner particles).

U.S. Pat. No. 5,286,917 discloses the use of silica in connection with a one-component developer to increase fluidity of the toner. Silica is also said to be used for the same reasons in U.S. Pat. No. 5,729,805. These patents are concerned with development systems which do not use carrier materials comprised of a hard magnetic material, and thus, have not dealt with the unique characteristics of a developing system which uses a hard magnetic carrier, and in particular, issues concerning toner dusting as previously mentioned.

As can be seen, it would be desirable to develop improved methods and materials which inhibit or minimize toner dusting, while also improving the ability of the toner to maintain charge as the developer ages, as well as other advantages.

### SUMMARY OF THE INVENTION

The present invention relates to the discovery that addition of silica materials of a particular particle size, which can include those treated with a silane or silicone-containing material so as to have a hydrophobic surface, as well as hydrophilic silicas, to the toner used in making the developer composition can reduce the dusting tendency and also increase charge stability over the life of the developer. Generally, the amount of such silica added is sufficient to minimize dust formation, but also to at least maintain the toner charge to mass (Q/m) characteristic as the developer ages in use. By the phrase, “to at least maintain the toner charge to mass (Q/m) ratio”, or its equivalent, it is meant that during use of the toner in an electrographic process for at least about 10 hours and preferably at least about 40 hours, the Q/m value (as an absolute value) during use is maintained at a value of at least about 50% of the initial Q/m value for the toner, and in preferred embodiments, the Q/m value is maintained at a value of at least about 75% of the initial Q/m value, more preferably at least about 90% of the initial Q/m value, and most preferably is maintained at a value greater than the initial Q/m value for the toner. The “initial Q/m value” is the toner charge to mass at the start of such use in the process. By the phrase, “minimize dust formation”, or its equivalent, it is meant that the toner dust level or throw off is desirably less than about 5 grams/hour (g/hr), preferably less than about 2 g/hr, more preferably less than about 0.5 g/hr, and most preferably less than 0.1 g/hr.

The amount of silica used can vary depending on the particle size of the toner, but generally an amount of silica of from about 0.1 wt % to about 5 wt %, preferably from about 0.25 wt % to about 2.5 wt %, more preferably from about 0.4 wt % to about 2 wt %, and most preferably from about 0.5 to 1.7 wt % based on total weight of the toner is employed. The foregoing amounts are particularly preferred for use with toner resins having an average particle size of about 4-12 μm, wherein the average particle size is determined by use of a well-known Coulter Counter device. It should be understood that as the toner particle size decreases, the amount of silica needed to obtain the same effects will generally need to be increased, since a smaller toner particle size yields a toner with a higher overall surface area to treat.

Thus, in one aspect, the present invention is directed to an electrostatic dry developer composition for use in the development of electrostatic latent images. The developer composition comprises a mixture of charged toner particles and oppositely charged carrier particles comprised of a hard magnetic material, with the toner particles having dispersed on the outer surfaces thereof particles of a hydrophobic or hydrophilic silica having a BET surface area of greater than about 50 m²/g.

In another aspect, the present invention is directed to a method for development of an electrostatic image comprising contacting the image with at least one magnetic brush comprising (a) a rotating magnetic core of a pre-selected magnetic field strength, (b) an outer nonmagnetic shell disposed about the rotating magnetic core, and (c) an electrographic developer composition comprising a mixture of charged toner particles and oppositely charged carrier particles comprised of a hard magnetic material, the toner particles having dispersed on the outer surfaces thereof particles of a hydrophobic or hydrophilic silica having a BET surface area of greater than about 50 m²/g.

### BRIEF DESCRIPTION OF THE DRAWINGS

FIG. 1 is a graph of charge-to-mass (Q/m) in terms of microcoulombs per gram (μIC/g) (determined by the ET and VP methods described hereinafter) versus developer age (in hours) and is discussed in reference to Examples 1-3 hereinafter.

FIG. 2 is a graph of charge-to-mass (Q/m) in terms of μIC/g (by the MECCA method described hereinafter) versus developer age (in hours) and is discussed in reference to Examples 4-7 hereinafter.

FIG. 3 is a graph of on-line toner throw-off in terms of grams per hour (g/h) versus developer age (in hours) and is discussed in reference to Examples 4-7 hereinafter.

FIG. 4 is a graph of charge-to-mass (Q/m) in terms of μC/g (as determined by both the MECCA and VP methods) and on-line toner throw-off in g/h versus developer age (in hours) and is discussed in reference to Examples 8-9 hereinafter.

FIG. 5 is a graph of charge-to-mass (Q/m) in terms of μC/g and admix dust level (in micrograms—mg) versus the amount of silica surface treatment on the toner (in terms of wt % based on total weight of the toner) and is discussed in reference to Examples 10-12 and Comparative Examples A-B hereinafter.

FIG. 6 is a graph of charge-to-mass (Q/m) in terms of μC/g (as determined by the MECCA method) and admix dust level (mg) versus the amount of silica surface treatment on the toner (in terms of wt % based on total weight of the toner) and is discussed in reference to Examples 13-14 hereinafter

### DETAILED DESCRIPTION OF THE INVENTION

The present invention relates to developer compositions which are two-component materials comprised of particles of a hard magnetic carrier material and toner particles. The present inventors have discovered that addition of silica-containing materials of a particular particle size, which can include those treated with a silane or silicone-containing material so as to have a hydrophobic surface, as well as hydrophilic silicas, to the toner used in making the developer composition can reduce the dusting tendency and also increase charge stability over the life of the developer.

As previously pointed out in connection with U.S. Pat. Nos. 4,546,060 and 4,473,029, the disclosures of which have been incorporated herein by reference, the use of “hard” magnetic materials as carrier particles increases the speed of development dramatically when compared with carrier particles made of “soft” magnetic particles. The preferred ferrite materials disclosed in these patents include barium, strontium and lead ferrites having the formula MO.6Fe₂O₃ wherein M is barium, strontium or lead. These materials generally have a single-phase, hexagonal crystal structure.

The efficiency of development when employing ferrite carriers is limited by the resistivity of the ferrite materials themselves. For example, because these materials have a resistivity of approximately 1×10₁₁ ohm-cm. However, in order to obtain high quality copies of the original image, it is necessary to maintain high magnetic properties; i.e. a coercivity of at least about 300 Oersteds when magnetically saturated and an induced magnetic moment of at least about 20 EMU/gm when in an applied field of 1000 Oersteds while at the same time increasing the conductivity of the particles.

The preparation of magnetic ferrites generally and hard, hexagonal crystal structure ferrites (Ba, Sr or Pb) in particular, are well documented in the literature. Any suitable method of making the ferrite particles may be employed, such as the methods disclosed in U.S. Pat. Nos. 3,716,630, 4,623,603 and 4,042,518, the teachings of which are incorporated herein by reference in their entirety; European Patent Application No. 0 086 445; “Spray Drying” by K. Masters published by Leonard Hill Books London, pages 502-509 and “Ferromagnetic Materials”, Volume 3 edited by E. P. Wohlfarth and published by North-Holland Publishing Company, Amsterdam, N.Y., Oxford, pages 315 et seq, the teachings of which are also incorporated herein by reference. For example, if the ferrite to be prepared is a hard magnetic strontium ferrite, then from about 8 to 12 parts SrCO₃ and 85 to 90 parts of Fe₂O₃ are mixed with a dispersant polymer, gum arabic, and water as a solvent to form a slurry. The solvent is removed by spray drying the slurry and the resultant green beads are fired at from about 1100° C. to about 1300° C. to form the desired hard magnetic ferrite material described above. The ferrite material is then deagglomerated and/or milled to reduce the particle size to that generally required of carrier particles, that is, less than 100 μm and preferably from about 3 to 65 μm, and the resulting carrier particles are then permanently magnetized by subjecting them to an applied magnetic field of sufficient strength to magnetically saturate the particles as described herein.

The present invention comprises two types of carrier particles. The first of these carriers comprises a binder-free, magnetic particulate hard magnetic ferrite material such as that employed in U.S. Pat. No. 4,546,060, which may or may not be doped with at least one multi-valent metal ion such as the carriers described in U.S. Pat. No. 4,764,445 and co-pending U.S. patent application Ser. Nos. 09/572,988 and 09/572,989, both filed on May 17, 2000, the disclosures of such patents and patent applications being incorporated herein by reference in their entirety, and which carrier particles exhibit the requisite coercivity and induced magnetic moment as previously described. These types of carriers are preferred.

The second carrier is heterogeneous and comprises a composite of a binder (also referred to as a matrix) and a magnetic material exhibiting the requisite coercivity and induced magnetic moment. The hard magnetic ferrite material as previously described herein is dispersed as discrete smaller particles throughout the binder. However, binders employed as known to those in the art can be highly resistive in nature, such as in the case of a polymeric binder, such as vinyl resins like polystyrene, polyester resins, nylon resins, and polyolefin resins as described in U.S. Pat. No. 5,256,513.

The individual bits of the magnetic ferrite material should preferably be of a relatively uniform size and sufficiently smaller in diameter than the composite carrier particle to be produced. Typically, the average diameter of the magnetic material should be no more than about 20 percent of the average diameter of the carrier particle. Advantageously, a much lower ratio of average diameter of magnetic component to carrier can be used. Excellent results are obtained with magnetic powders of the order of 5 μm down to 0.05 μm average diameter. Even finer powders can be used when the degree of subdivision does not produce unwanted modifications in the magnetic properties and the amount and character of the selected binder produce satisfactory strength, together with other desirable mechanical and electrical properties in the resulting carrier particle.

The concentration of the magnetic material in the composite can vary widely. Proportions of finely divided magnetic material, from about 20 percent by weight to about 90 percent by weight, of composite carrier can be used as long as the resistivity of the particles is that representative of the ferrite particles as described above.

The induced moment of composite carriers in a 1000 Oersteds applied field is dependent on the concentration of magnetic material in the particle. It will be appreciated, therefore, that the induced moment of the magnetic material should be sufficiently greater than about 20 EMU/gm to compensate for the effect upon such induced moment from dilution of the magnetic material in the binder. For example, one might find that, for a concentration of about 50 weight percent magnetic material in the composite particles, the 1000 Oersteds induced magnetic moment of the magnetic material should be at least about 40 EMU/gm to achieve the minimum level of 20 EMU/gm for the composite particles.

The binder material used with the finely divided magnetic material is selected to provide the required mechanical and electrical properties. It should (1) adhere well to the magnetic material, (2) facilitate formation of strong, smooth-surfaced particles and (3) preferably possess sufficient difference in triboelectric properties from the toner particles with which it will be used to insure the proper polarity and magnitude of electrostatic charge between the toner and carrier when the two are mixed.

The matrix can be organic, or inorganic, such as a matrix composed of glass, metal, silicone resin or the like. Preferably, an organic material is used such as a natural or synthetic polymeric resin or a mixture of such resins having appropriate mechanical properties. Appropriate monomers (which can be used to prepare resins for this use) include, for example, vinyl monomers such as alkyl acrylates and methacrylates, styrene and substituted styrenes, and basic monomers such as vinyl pyridines. Copolymers prepared with these and other vinyl monomers such as acidic monomers, e.g., acrylic or methacrylic acid, can be used. Such copolymers can advantageously contain small amounts of polyfunctional monomers such as divinylbenzene, glycol dimethacrylate, triallyl citrate and the like. Condensation polymers such as polyesters, polyamides or polycarbonates can also be employed.

Preparation of composite carrier particles according to this invention may involve the application of heat to soften thermoplastic material or to harden thermosetting material; evaporative drying to remove liquid vehicle; the use of pressure, or of heat and pressure, in molding, casting, extruding, or the like and in cutting or shearing to shape the carrier particles; grinding, e.g., in a ball mill to reduce carrier material to appropriate particle size; and sifting operations to classify the particles.

According to one preparation technique, the powdered magnetic material is dispersed in a solution of the binder resin. The solvent may then be evaporated and the resulting solid mass subdivided by grinding and screening to produce carrier particles of appropriate size. According to another technique, emulsion or suspension polymerization is used to produce uniform carrier particles of excellent smoothness and useful life.

The coercivity of a magnetic material refers to the minimum external magnetic force necessary to reduce the induced magnetic moment from the remanance value to zero while it is held stationary in the external field, and after the material has been magnetically saturated, i.e., the material has been permanently magnetized. A variety of apparatus and methods for the measurement of coercivity of the present carrier particles can be employed. For the present invention, a Lakeshore Model 7300 Vibrating Sample Magnetometer, available from Lakeshore Cryotronics of Westerville, Ohio, is used to measure the coercivity of powder particle samples. The magnetic ferrite powder is mixed with a nonmagnetic polymer powder (90 percent magnetic powder; 10 percent polymer by weight). The mixture is placed in a capillary tube, heated above the melting point of the polymer, and then allowed to cool to room temperature. The filled capillary tube is then placed in the sample holder of the magnetometer and a magnetic hysteresis loop of external field (in Oersteds) versus induced magnetism (in EMU/gm) is plotted. During this measurement, the sample is exposed to an external field of 0 to ±8000 Oersteds.

The carrier particles may be coated to properly charge the toner particles of the developer. This can be done by forming a dry mixture of the ferrite material with a small amount of powdered resin, e.g., from about 0.05 to about 3.0 weight percent resin based on total weight of the ferrite material and resin, and then heating the mixture to fuse the resin. Such a low concentration of resin will form a thin or discontinuous layer of resin on the ferrite particles.

Various resin materials can be employed as a coating on the hard magnetic carrier particles. Examples include those described in U.S. Pat. Nos. 3,795,617; 3,795,618, and 4,076,857, the teachings of which are incorporated herein by reference in their entirety. The choice of resin will depend upon its triboelectric relationship with the intended toner. For use with toners which are desired to be positively charged, preferred resins for the carrier coating include fluorocarbon polymers such as poly(tetrafluoroethylene), poly(vinylidene fluoride) and poly(vinylidene fluoride-co-tetrafluoroethylene). For use with toners which are desired to be negatively charged, preferred resins for the carrier include silicone resins, acrylic resins, as well as mixtures of resins, such as a mixture of poly(vinylidene fluoride) and polymethylmethacrylate. Various polymers suitable for such coatings are also described in U.S. Pat. No. 5,512,403, the teachings of which are incorporated herein by reference in their entirety.

The developer is formed by mixing the carrier particles with toner particles in a suitable concentration. Within developers of the invention, high concentrations of toner can be employed. Accordingly, the present developer preferably contains from about 70 to 99 weight percent carrier and about 30 to 1 weight percent toner based on the total weight of the developer; most preferably, such concentration is from about 75 to 99 weight percent carrier and from about 25 to 1 weight percent toner.

The toner component of the invention can be a powdered resin which is optionally colored. It normally is prepared by compounding a resin with a colorant, i.e., a dye or pigment, either in the form of a pigment flush (a special mixture of pigment press cake and resin well-known to the art) pigment-resin masterbatch, or pure dry bulk pigment, as well as any other desired addenda known to the art. If a developed image of low opacity is desired, no colorant need be added. Normally, however, a colorant is included and it can, in principle, be any of the materials mentioned in Colour Index, Vols. I and II, 2nd Edition. Carbon black is especially useful. The amount of colorant can vary over a wide range, e.g., from about 2 to about 20 weight percent of the toner component. Combinations of colorants may be used as well.

The mixture of resin and colorant is heated and milled to disperse the colorant and other addenda in the resin. The mass is cooled, crushed into lumps and finely ground. The resulting toner particles can range in diameter from about 0.5 to about 25 μm with an average size of from about 1 to about 16 μm. Preferably, the average particle size ratio of carrier to toner particles lies within the range from about 15:1 to about 1:1. However, carrier-to-toner average particle size ratios of as high as 50:1 are useful.

The toner resin can be selected from a wide variety of materials, including both natural and synthetic resins and modified natural resins, as disclosed, for example, in U.S. Pat. No. 4,076,857. Especially useful are the crosslinked polymers disclosed in U.S. Pat. Nos. 3,938,992 and 3,941,898. The crosslinked or non-crosslinked copolymers of styrene or lower alkyl styrenes with acrylic monomers such as alkyl acrylates or methacrylates are particularly useful. Also useful are condensation polymers such as polyesters. Numerous polymers suitable for use as toner resins are disclosed in U.S. Pat. No. 4,833,060. The teachings of U.S. Pat. Nos. 3,938,992, 3,941,898, 4,076,857; and 4,833,060 are incorporated by reference herein in their entirety.

The shape of the toner can be irregular, as in the case of ground toners, or spherical. Spherical particles are obtained by spray-drying a solution of the toner resin in a solvent. Alternatively, spherical particles can be prepared by the polymer bead swelling technique disclosed in European Pat. No. 3905 published Sep. 5, 1979, to J. Ugelstad, as well as by suspension polymerization, such as the method disclosed in U.S. Pat. No. 4,833,060, the teachings of which are incorporated by reference herein in their entirety.

The toner can also contain minor amounts of additional components as known to the art, such as charge control agents and antiblocking agents. Especially useful charge control agents are disclosed in U.S. Pat. Nos. 3,893,935 and 4,206,064, and British Pat. No. 1,501,065, the teachings of which are incorporated herein by reference in their entirety. Quaternary ammonium salt charge agents as disclosed in Research Disclosure, No. 21030, Volume 210, October, 1981 (published by Industrial Opportunities Ltd., Homewell, Havant, Hampshire, P09 1 EF, United Kingdom) are also useful.

Generally, the amount of such silica added is sufficient to minimize dust formation, but also to at least maintain the Q/m charge ratio of the toner as the developer ages in use. The amount of silica will vary somewhat depending on the particle size of the toner, but generally an amount of from about 0.1 wt % to about 5 wt %, and preferably from about 0.25 wt % to about 2.5 wt %, more preferably from about 0.4 to about 2 wt %, and most preferably from about 0.5 to 1.7 wt % based on total weight of the toner is employed as mentioned hereinabove.

In an embodiment of the method of the present invention, an electrostatic image is brought into contact with a magnetic brush development station comprising a rotating magnetic core, an outer non-magnetic shell, and the two-component dry developers as described hereinabove. The electrostatic image so developed can be formed by a number of methods such as by imagewise photodecay of a photoreceptor, or imagewise application of a charge pattern on the surface of a dielectric recording element. When photoreceptors are employed, such as in high-speed electrophotographic copy devices, the use of halftone screening to modify an electrostatic image can be employed, the combination of screening with development in accordance with the method for the present invention producing high-quality images exhibiting high Dmax and excellent tonal range. Representative screening methods including those employing photoreceptors with integral half-tone screens are disclosed in U.S. Pat. No. 4,385,823.

The invention is further illustrated by the following examples:

### Specific Embodiments of the Invention

In the following examples, all parts and percentages are by weight and temperatures are in degrees Celsius (° C.), unless otherwise indicated.

### EXAMPLES 1-3

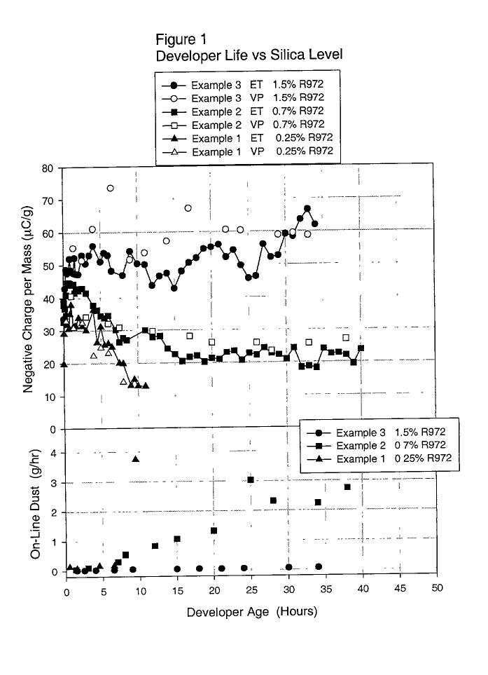

FIG. 1 shows data for negative polarity developers made with hard magnetic carrier particles (hard strontium ferrite) and a toner treated with varying concentrations of silica according to the present invention.

In Examples 1-3 respectively, a hydrophobized silica (R972 obtained from Degussa of Germany) is added to the toner in an amount of 0.25%, 0.7% and 1.5% by weight, based on total weight of the toner. The R972 silica has been rendered hydrophobic by surface treatment thereof with dichlorodimethylsilane, and has a surface area of approximately 130 (±25) square meters per gram (m²/g) prior to the hydrophobizing surface treatment according to the manufacturer as determined by well known BET analysis. After the hydrophobizing treatment, the R972 silica has a BET surface area of 110 m²/g according to the manufacturer.

The toner is made by mixing a polyester resin with a copper phthalocyanine pigment “flush”, together with a charge control agent, i.e., Bontron E-88 obtained from Orient Chemicals of Japan, which is an aluminum complex of ditertbutylsalicylic acid. The foregoing materials are extrusion blended, and then pulverized into a particulate form. The toner is classified to yield a volume median particle size of about 8 μm as determined by a Coulter Counter device.

The resulting toner is surface treated by powder blending the pulverized and classified toner particles with the R972 surface treatment agent in a high-energy mixer Henschel FM75 mixer obtained from Thyssen Henschel Industrietechnik GmbH of Kassel, Germany. The toner and the R972 silica are added to the mixer in amounts sufficient to yield the above-described weight percentages, and thereafter the mixer is operated at a speed of 1745 revolutions per minute (rpm) for 2.5 minutes. Subsequently, the resulting toner/silica mixture is collected and sieved with a 325 mesh screen to remove agglomerated silica particles. The resulting sieved surface treated toner is then further employed to prepare developers as described hereinbelow.

The carrier employed is a hard magnetic strontium ferrite particulate material obtained from POWDERTECH of Valpariso, Ind. The carrier as obtained is coated with a silicone resin.

The developer is made by blending the toner and carrier in amounts such that the resulting developer consists of 6 weight percent toner, with the balance of the developer composition being carrier.

A set of developer life tests were conducted on a life test fixture. The life test fixture comprises a toning station similar to that disclosed in U.S. Pat. No. 4,473,029, the teachings of which are incorporated herein in the entirety by reference. The toning station has a mixing sump with magnetic toner concentration monitor, feed mechanism (transport roller or bucket brigade plus feed skive), rotating core and shell toning roller, and toner replenishment unit. Toner is taken out continuously by bias development onto a metal drum, from which it is removed by a blade cleaning mechanism. As toner is depleted from the station, the magnetic monitor and control circuitry add replenisher toner such that the toner concentration in the sump is held constant. The rate of takeout is controlled by the bias development voltage. Charge per mass is measured off-line by the ET method or MECCA method as described hereinafter, and is measured on-line by vacuum probe (the VP method) of the toner from the metal drum before it is skived off. Dust is measured by means of a vacuum filter unit mounted adjacent to the toning roller itself, generally collection is done for approximately 15 minutes and the dust collected is reported as grams per hour (g/h).

The toner Q/m ratio can be measured in a MECCA device comprised of two spaced-apart, parallel, electrode plates which can apply both an electrical and magnetic field to the developer samples, thereby causing a separation of the two components of the mixture, i.e., carrier and toner particles, under the combined influence of a magnetic and electric field. A 0.100 g sample of a developer mixture is placed on the bottom metal plate. The sample is then subjected for thirty (30) seconds to a 60 Hz magnetic field and potential of 2000 V across the plates, which causes developer agitation. The ET method is essentially identical to the MECCA method, except that it employs a rotating magnetic field. The toner particles are released from the carrier particles under the combined influence of the magnetic and electric fields and are attracted to and thereby deposit on the upper electrode plate, while the magnetic carrier particles are held on the lower plate. An electrometer measures the accumulated charge of the toner on the upper plate. The toner Q/m ratio in terms of microcoulombs per gram (μC/g) is calculated by dividing the accumulated charge by the mass of the deposited toner taken from the upper plate.

In FIG. 1, the charge per mass (Q/m), in microcoulombs per gram (μC/g), is seen to be higher as the amount of the silica surface treatment concentration on the toner increases, and the dusting level is also seen to be lower as the concentration of silica increases.

### EXAMPLES 4-7

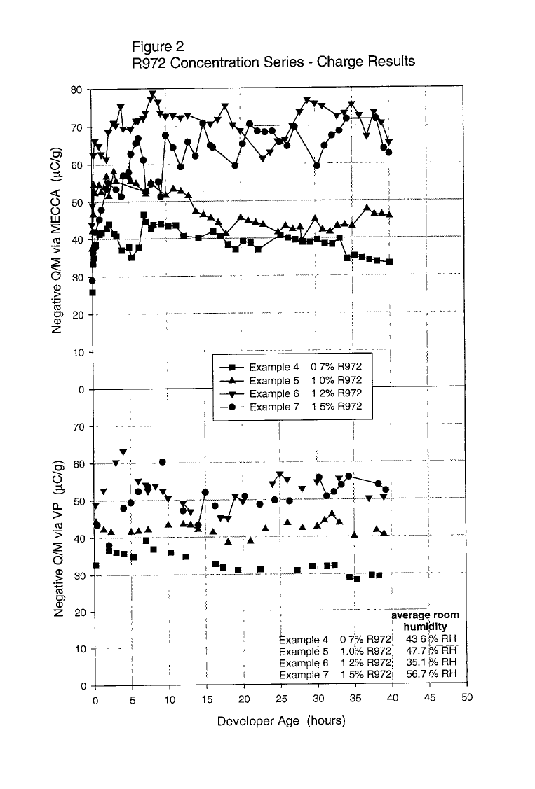

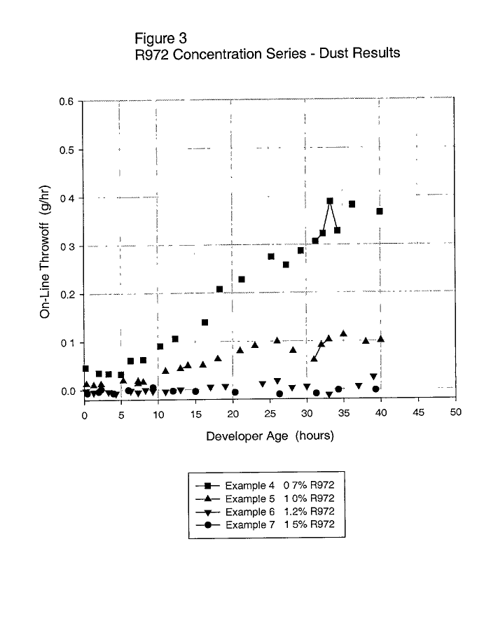

FIGS. 2 and 3 show the results of an R972 silica concentration series (0.7%, 1.0%, 1.2% and 1.5% by weight based on total weight of the toner) and developer life for Examples 4-7, which are substantially similar to that of Examples 1-3 except as specified hereinbelow.

The toner is made in substantially the same manner as Examples 1-3, except the charge control agent is Bontron E-84 obtained from Orient Chemicals, which is a zinc complex of ditertbutylsalicylic acid. The toner has a volume median average particle size of 8 μm as determined by a Coulter Counter.

The carrier is also coated with a 60 wt % polyvinylidene fluoride - 40 wt % polymethylmethacrylate mixture, rather than the silicone coating of Examples 1-3. The carrier is coated with this polymer mixture by admixing the polymer with the carrier, followed by heating the admixture in an oven to a point sufficient to fuse the polymer mixture to the carrier. The polymer mixture is coated onto the carrier in an amount of about 1.23 weight percent based on total carrier weight.

The developer also consists of 6 weight percent toner, with the balance being carrier.

As can be seen, increasing the R972 surface treatment concentration results in an increase in Q/m (FIG. 2), and a decrease in dusting (FIG. 3) as a function of developer age. These tests are run over the course of time, resulting in the relative humidity sensitivity of the developer influencing the relative charge levels of the toner. The 1.5 wt % test is run in high humidity conditions typical of summer weather, which conditions depress charge level relative to the 1.2 wt % test which is run under drier weather conditions. Thus, it is believed that the 1.5 wt % material has a higher charging ability than the 1.2 wt % material, even though in the figures they appear to look about the same.

### EXAMPLE 8-9

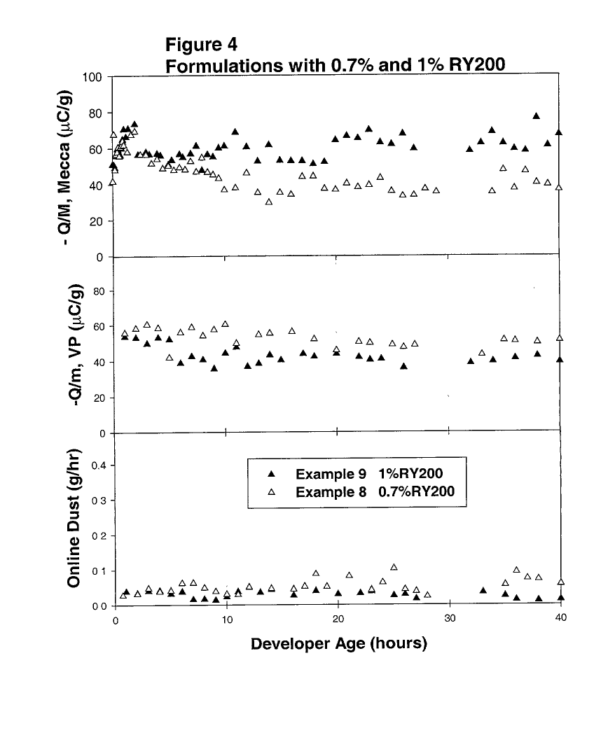

In Examples 8-9, the procedure of Examples 4-7 is substantially repeated, except as described hereinafter. FIG. 4 shows the results for life test fixture experiments using a similar developer using the same carrier as described in Examples 4-7. The toner uses the same components, except that the colorant used is a carbon black, i.e., Regal 330 obtained from Cabot Corporation of Boston, Mass. The toner is surface treated with RY200 silica obtained from Degussa of Germany (wherein the silica before being hydrophobized has a surface area of 200 (±25) m²/g according to the manufacturer as determined by BET analysis), and the silica is added to the toner in amounts of 0.7% and 1.0% by weight based on total weight of the toner. The RY200 silica as obtained from the manufacturer is surface treated with a silicone oil to render its surface hydrophobic. As with the R972 silica, it is seen in FIG. 4 that an increasing silica level results in a decrease in dusting as a function of developer age. The charge for the higher silica content toner was higher by the MECCA method and the VP method. The MECCA method measures the entire developer sample (develops all the available toner), while the VP method looks at the toner that develops out of a representative toning process (known to develop only a fraction of the available toner).

Based on the foregoing examples, the fundamental phenomena and performance improvements associated with silica appear to be the same for either type of carrier surface coating, i.e., the silicone resin or polyvinylidene fluoride/polymethylmethacrylate resin blend, and for either type of silica, i.e., the R972 or RY200 silicas.

While not wishing to be bound by theory, electron microscope data seem to indicate that the silica freely moves around between toner particles, and as a result, the freely transferable silica can result in charge sharing with fresh replenisher toner, thus minimizing the dust problem.

The effect of increased charge and decreased toner dusting, i.e., “throwoff” is more pronounced where the primary particle size of the silica is smaller. Generally, the particle size should be such that the surface area is greater than about 50 m²/g as determined by BET analysis of the silica particles prior to any surface treatment of the silica, and preferably from about 100 to about 410 m²/g by such BET analysis. The BET analysis should be preformed prior to surface treatment, since the surface treatment will alter the surface properties of the silica and give incorrect particle size data if the analysis is done after the surface treatment.

### EXAMPLES 10-12 AND COMPARATIVE EXAMPLES A-B

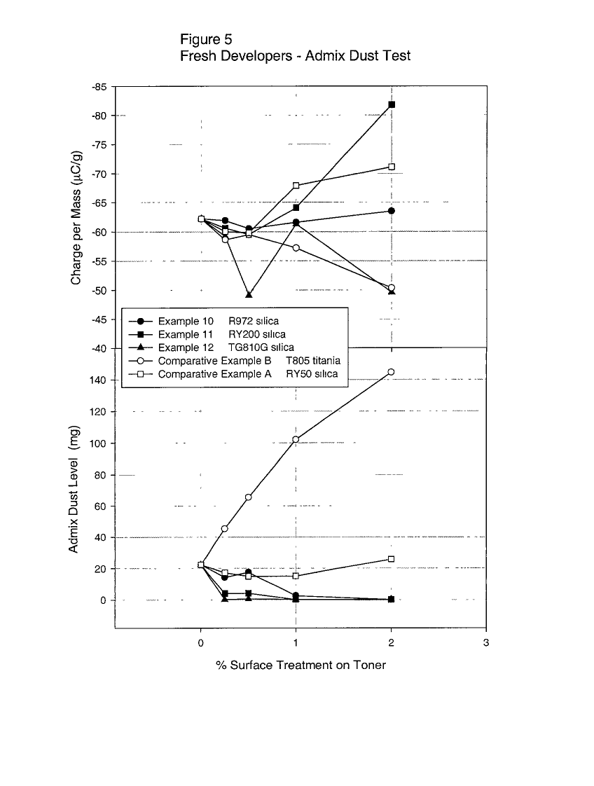

The admix dust test as described hereinafter is used to characterize dust levels. FIG. 5 shows the results for silica concentration experiments using a developer prepared using the silicone coated carrier particles of Examples 1-3. The toner comprises a polyester binder resin, pigment red 57:1 magenta pigment, and the Bontron E-88 charge control agent. The silicas used are the R972 and RY200 silicas previously mentioned, as well as TG810G silica obtained from Cabot Corporation. The TG810G silica has a BET surface area of 325 (±25) m²/g (before hydrophobizing treatment) according to the manufacturer as determined by BET analysis.

The developers, which have a toner concentration (TC) of 8 wt % based on total weight of the developer composition, are mixed for 2 minutes on a robot wrist shaker, and then for 10 minutes on a bottle brush device. The first exercise period consists of vigorously shaking the developer to cause triboelectric charging by placing a 4-7 g portion of the developer into a 4 dram glass screw cap vial, capping the vial and shaking the vial on a “wrist-action” robot shaker operated at about 2 Hertz (Hz) and an overall amplitude of about 11 centimeters (cm) for 2 minutes.

The developer is also subjected to an additional, exercise period of 10 minutes on top of a rotating-core magnetic brush. The vial as taken from the robot shaker is constrained to the brush while the magnetic core is rotated at 2000 rpm to approximate actual use of the developer in an electrographic process. Thus, the developer is exercised as if it were directly on a magnetic brush, but without any loss of developer, because it is contained within the vial. Toner charge level after this exercise is designated as “10 min BB” or “10 minute bottle brush”.

The Q/m for the toner is measured according to the ET method. Then an additional amount (4 wt %) of the same toner is added, (the admix step in FIG. 5) the developers are wrist-shaken for a further 15 seconds, and then placed on a small rotating magnetic core toning roller, with the vacuum filter unit placed directly above the roller. The toner particles collected on the filter after 1 minute of running time is reported as the dust, i.e., throwoff, value in FIG. 5. It is seen that increasing the quantity of the R972, RY200, TG810G silicas on the toner results in a decrease in dusting. These silicas have hydrophobizing treatments consisting of dichlorodimethylsilane, silicone oil, and hexamethyldisilazane, respectively, and surface areas of the starting silica prior to surface treatment of approximately 130, 200 and 325 m²/g, respectively.

A fourth silica sample (Comparative Example A), RY50 (obtained from Degussa), is shown not to have improved throwoff; this has a silicone oil treatment, but has a BET surface area value of 50 m²/g for the starting silica (a larger primary particle size than the other three silicas) without taking into account any variation in the BET method. Thus, the particle size of the silica should be greater than about 50 m²/g such that the toner exhibits improved dusting performance in a hard magnetic carrier development process.

A fifth sample (Comparative Example B) on these plots is a hydrophobic titania, T805, obtained from Degussa. The titania material is shown to cause a marked increase in dusting, which is not desirable.

### EXAMPLES 13-14

The procedure of Examples 4-7 is substantially repeated, except that a hydrophilic, fumed silica (Aerosil 200 obtained from Degussa, and having a specific surface area of 200 m²/g as determined by BET analysis) is employed rather than hydrophobized R972 silica. The amount of silica employed is 0.7 wt % for Example 13 and 1.2 wt % for Example 14, based on total weight if the toner. The charge to mass and dust level characteristics for the resulting developers are determined by use of the MECCA and on-line dust tests described in Examples 1-3.

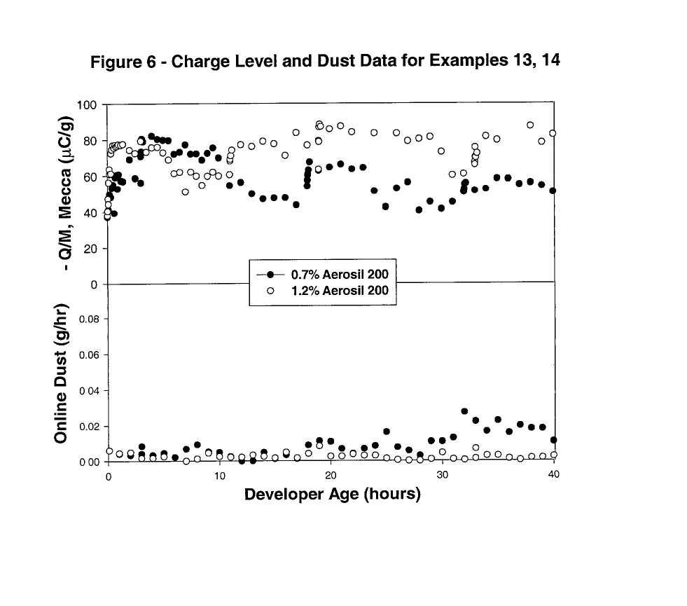

The data for Examples 13-14 is illustrated in FIG. 6. As can be seen, the amount of hydrophilic silica employed as a surface treatment can also be used to control charge level and the dust level as described in Examples 1-12.

Similar results are obtained for other hydrophobized and hydrophilic silicas having the same or similar particle size ranges.

Data obtained using hydrophobized silicas as a surface treatment for toner in the developer compositions of the invention also suggests that such silicas can resist “embedment”, which is a tendency for silica particles to penetrate the surface of the toner resin binder and to have at least a portion of the silica particle to bury itself, i.e., become engulfed, within the resin. A method for preparing surface-treated toner wherein silica and/or titania particles are embedded within a toner resin binder is disclosed in U.S. Pat. Nos. 6,197,446 and 6,200,722, the teachings of which are incorporated herein by reference. It has been found that such embedment is not always desirable for silica, since the silica's performance with respect to dust control and assisting with maintenance of charge levels is believed to be reduced by embedment. “Electrography” and “electrographic” as used herein are broad terms that include image-forming processes involving the development of an electrostatic charge pattern formed on a surface with or without light exposure, and thus includes electrophotography and other similar processes.

Although the invention has been described in considerable detail, and with particular reference to preferred embodiments, it should be understood that variations and modifications to such embodiments can be made within the scope of the invention.

What is claimed is:

1. An electrostatic dry developer composition for use in the development of electrostatic latent images, the developer composition comprising a mixture of charged toner particles and oppositely charged carrier particles comprised of a hard magnetic material, the toner particles having dispersed on the outer surfaces thereof silica particles having a BET surface area of greater than about 50 m²/g.

2. The developer composition of claim 1 wherein the silica is a hydrophobic silica, the silica particles having a BET surface area of greater than about 50 m²/g prior to a hydrophobizing surface treatment of the silica particles.

3. The developer composition of claim 2 wherein the silica is a hydrophobic silica that has been surface treated with dichlorodimethylsilane, silicone oil, or hexamethyldisilazane.

4. The developer composition of claim 2 wherein the silica particles have a BET surface area of from about 100 to about 410 m²/g prior to the hydrophobizing surface treatment of the silica particles.

5. The developer composition of claim 1 wherein the silica is a hydrophilic silica.

6. The developer composition of claim 1 wherein the silica has a BET surface area of from about 100 to about 410 m²/g.

7. The developer composition of claim 1 wherein the toner particles have an average particle size of from about 4 to 12 μm.

8. The developer composition of claim 1 wherein the amount of silica employed is from about 0.1 to about 5 weight percent, based on total weight of the toner particles.

9. The developer composition of claim 1 wherein the amount of silica employed is from about 0.4 to about 2 weight percent, based on total weight of the toner particles.

10. The developer composition of claim 1 wherein the amount of silica employed is from about 0.5 to 1.7 weight percent, based on total weight of the toner particles.

11. The developer composition of claim 1 wherein the hard magnetic material is a hard magnetic ferrite.

12. The developer composition of claim 11 wherein the hard magnetic ferrite is strontium ferrite.

13. The developer composition of claim 1 wherein the toner particles have an initial charge to mass ratio (Q/m) when used in an electrographic process, the silica particles being employed in an amount sufficient to maintain a Q/m value of at least 50% of the initial Q/m value as the developer composition is used in the electrographic process.

14. The developer composition of claim 13 wherein the silica particles are employed in an amount sufficient to maintain a Q/m value for the toner of at least 90% of the initial Q/m value.

15. The developer composition of claim 13 wherein the silica particles are employed in an amount sufficient to maintain a Q/m value greater than the initial Q/m value.

16. The developer composition of claim 1 wherein the silica particles are used in an amount sufficient to maintain a toner dust level of less than 5 g/hr.

17. The developer composition of claim 1 wherein the silica particles are used in an amount sufficient to maintain a toner dust level of less than about 0.5 g/hr.

18. The developer composition of claim 1 wherein the silica particles are used in an amount sufficient to maintain a toner dust level of less than about 0.1 g/hr.

19. A method for development of an electrostatic image comprising contacting the image with at least one magnetic brush comprising (a) a rotating magnetic core of a pre-selected magnetic field strength, (b) an outer nonmagnetic shell disposed about the rotating magnetic core, and (c) an electrographic developer composition disposed on an outer surface of the shell and in contact with the image, the developer composition comprising a mixture of charged toner particles and oppositely charged carrier particles comprised of a hard magnetic material, the toner particles having dispersed on the outer surfaces thereof silica particles with a BET surface area of greater than about 50 m²/g.

20. The method of claim 19 wherein the silica is a hydrophobic silica, the silica particles having a BET surface area of greater than about 50 m²/g prior to a hydrophobizing surface treatment of the silica particles.

21. The method of claim 20 wherein the silica is a hydrophobic silica that has been surface treated with dichlorodimethylsilane, silicone oil, or hexamethyldisilazane.

22. The method of claim 20 wherein the silica particles have a BET surface area of from about 100 to about 410 m²/g prior to the hydrophobizing surface treatment of the silica particles.

23. The method of claim 19 wherein the silica is a hydrophilic silica.

24. The method of claim 19 wherein the silica has a BET surface area of from about 100 to about 410 m²/g.

25. The method of claim 19 wherein the toner particles have an average particle size of from about 4 to 12 μm.

26. The method of claim 19 wherein the amount of silica employed is from about 0.1 to about 5 weight percent, based on total weight of the toner particles.

27. The method of claim 19 wherein the amount of silica employed is from about 0.4 to about 2 weight percent, based on total weight of the toner particles.

28. The method of claim 19 wherein the amount of silica employed is from about 0.5 to 1.7 weight percent, based on total weight of the toner particles.

29. The method of claim 19 wherein the hard magnetic material is a hard magnetic ferrite.

30. The method of claim 29 wherein the hard magnetic ferrite is strontium ferrite.

31. The method of claim 19 wherein the toner particles have an initial charge to mass ratio (Q/m) during use of the developer composition in an electrographic process, the silica particles being employed in an amount sufficient to maintain a Q/m value for the toner of at least 50% of the initial Q/m value as the developer composition is used in the electrographic process.

32. The method of claim 31 wherein the silica particles are employed in an amount sufficient to maintain a Q/m value greater than the initial Q/m value.

33. The method of claim 19 wherein the silica particles are used in an amount sufficient to maintain a toner dust level of less than about 5 g/hr.

34. The method of claim 19 wherein the silica particles are used in an amount sufficient to maintain a toner dust level of less than about 0.5 g/hr.

35. The method of claim 19 wherein the silica particles are used in an amount sufficient to maintain a toner dust level of less than about 0.1 g/hr.
